(19) United States
(12) Patent Application Publication
(10) Pub. No.: US 2026/0180883 A1
(43) Pub. Date: Jun. 25, 2026

(54) METHOD AND APPARATUS FOR DETECTING ABNORMAL PACKET TRANSMISSION LATENCY

(71) Applicant: MEDIATEK INC., Hsinchu City (TW)

(72) Inventors: Ting-Ying LI, Hsinchu City (TW); Wei-Hsu CHU, Hsinchu City (TW); Hsin-Ying LIEN, Hsinchu City (TW)

(21) Appl. No.: 19/383,871

(22) Filed: Nov. 10, 2025

Related U.S. Application Data
(60) Provisional application No. 63/736,705, filed on Dec. 20, 2024.

(51) Int. Cl. H04L 43/0852; H04L 41/16

(52) U.S. Cl. CPC H04L 43/0852; H04L 41/16

(57) ABSTRACT

A method for detecting abnormal packet transmission latency is provided. The method is implemented by a wireless device and includes performing a first measurement of packet transmission latency over a time period in a first scenario. The method further includes extracting a first feature from the first measurement of packet transmission latency. The method further includes determining whether first current packet transmission latency in the first scenario is abnormal using an artificial intelligence (AI) or machine-learning (ML)-based model based on the first feature.

### CROSS REFERENCE TO RELATED APPLICATIONS

This application claims the benefit of U.S. Provisional Application No. 63/736,705, entitled “AI-Based Detection of Packet Transmission Latency in Network Devices with Automatic Model Updating for New Scenarios and Applications”, filed on Dec. 20, 2024, the entirety of which is incorporated by reference herein.

### BACKGROUND OF THE INVENTION

### Field of the Invention

The present disclosure generally relates to wireless communication. More specifically, aspects of the present disclosure relate to a method and apparatus for detecting abnormal packet transmission latency.

### Description of the Related Art

Unless otherwise indicated herein, approaches described in this section are not prior art to the claims listed below and are not admitted as prior art by inclusion in this section.

Overall user experience may be impacted when network devices experience high packet transmission latency. For example, users generally expect low latency during activities such as video streaming, online gaming, and file transfers. To enhance user experience, it is desirable to detect the occurrence of high packet transmission latency and to perform corresponding optimizations to reduce its duration.

However, the definition of “high packet transmission latency” may vary across different usage scenarios, making it difficult to define a universal threshold. A threshold suitable for one scenario (Scenario A) may not be appropriate for another (Scenario B). For instance, acceptable packet transmission latency can differ depending on the user's environment, such as whether the network device is operating in a subway or on a highway. In another example, different applications, such as gaming, video streaming, or file transfers, may each have different acceptable latency levels. In this context, a scenario change may refer to a change in environmental conditions (e.g., location) or in the active application or service being used.

FIG. 1 illustrates several examples showing how the definition of high packet transmission latency varies depending on both environmental and application contexts. In the first example, when a user is playing an online game in a subway environment, a latency exceeding 50 milliseconds (ms) or 100 ms may already be considered high, since gaming applications are latency-sensitive. In another example, when the user performs an FTP transmission in the subway, a latency exceeding 300 ms may be acceptable because file transfer applications are generally tolerant of longer latency. Furthermore, when the user performs FTP transmission while traveling in a car, the acceptable threshold may decrease to around 150 ms, due to mobility and radio condition differences compared with the subway environment.

These examples demonstrate that the determination of high transmission latency depends on both environmental factors (e.g., subway vs. car) and application characteristics (e.g., gaming vs. file transfer). Therefore, how to accurately detect the high packet transmission latency or abnormal packet transmission latency in different scenarios is an urgent problem to be solved.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

In an exemplary embodiment, a method for detecting abnormal packet transmission latency is provided. The method is implemented by a wireless device and includes performing a first measurement of packet transmission latency over a time period in a first scenario. The method further includes extracting a first feature from the first measurement of packet transmission latency. The method further includes determining whether first current packet transmission latency in the first scenario is abnormal using an artificial intelligence (AI) or machine-learning (ML)-based model based on the first feature.

In some embodiments, the first feature includes a maximum packet transmission latency over the time period.

In some embodiments, the first feature includes a severity of packet transmission latency over the time period.

In some embodiments, the severity of packet transmission latency over the time period is evaluated based on average latency in the time period.

In some embodiments, the severity of packet transmission latency over the time period is evaluated by: segmenting latency values in the first measurement of packet transmission latency into a predetermined number of bins, wherein each bin is associated with a respective weight; and calculating the severity of packet transmission latency based on a proportion of packets in each bin and the respective weight corresponding to each bin.

In some embodiments, the method further comprises performing a second measurement of packet transmission latency over the time period in a second scenario when the first scenario is changed to the second scenario. The method further comprises updating the AI or ML-based model to obtain an updated AI or ML-based model by using normal data in a latency range from the second measurement of packet transmission latency in the second scenario. The method further comprises determining whether second current packet transmission latency in the second scenario is abnormal using the updated AI or ML-based model.

In some embodiments, the method further comprises establishing a threshold based on a second feature extracted from the normal data in the latency range. The method further comprises determining that the second current packet transmission latency in the second scenario is abnormal when an output corresponding to the second current packet transmission latency from the updated AI or ML-based model exceeds the threshold.

In some embodiments, the AI or ML-based model comprises statistical methods, including at least one of Z-score analysis and Interquartile Range (IQR) analysis.

In some embodiments, the AI or ML-based model comprises machine learning algorithms, including at least one of Isolation Forest, One-Class SVM, and Local Outlier Factor (LOF).

In some embodiments, the AI or ML-based model is a deep neural network including at least one of Convolutional Neural Networks (CNNs), autoencoders, and Recurrent Neural Networks (RNNs).

In an exemplary embodiment, an apparatus for detecting abnormal packet transmission latency is provided. The device comprises a memory and at least one processor coupled to the memory. The processor performs operations comprising performing a first measurement of packet transmission latency over a time period in a first scenario. The processor performs operations comprising extracting a first feature from the first measurement of packet transmission latency. The processor performs operations comprising determining whether first current packet transmission latency in the first scenario is abnormal using an artificial intelligence (AI) or machine-learning (ML)-based model based on the first feature.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale, as some components may be shown out of proportion to their size in actual implementation in order to clearly illustrate the concept of the present disclosure.

FIG. 1 illustrates several examples showing how the definition of high packet transmission latency varies depending on both environmental and application contexts.

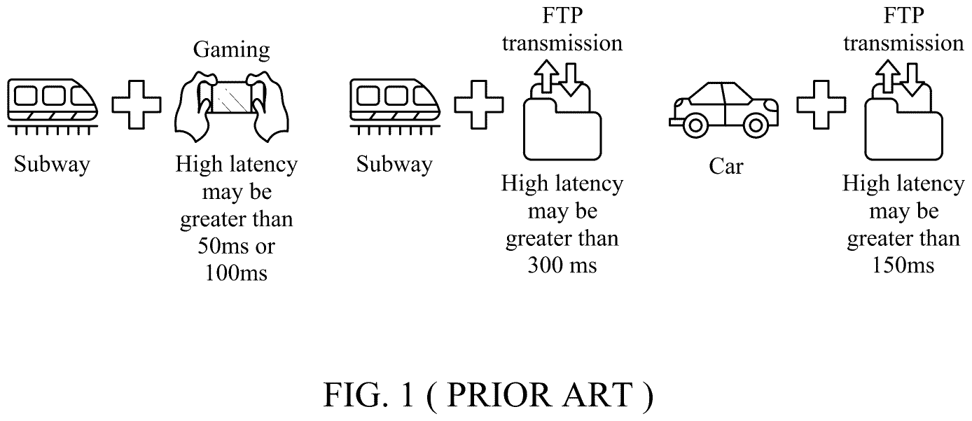

FIG. 2 is a block diagram of an example communication system in accordance with an implementation of the present disclosure.

FIG. 3 is a flowchart of an example process in accordance with an implementation of the present disclosure.

FIG. 4 illustrates an example of packet latency distributions across multiple cells in accordance with the present disclosure.

FIG. 5 illustrates an example of the relationship between input and output in an AI or ML-based model in accordance with the present disclosure.

### DETAILED DESCRIPTION OF THE INVENTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not shown) by the same numerals in the example figures. However, the features in different implementations may differ in other respects, and thus shall not be narrowly confined to what is shown in the figures.

The description uses the phrases “in one implementation” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. The expression “at least one of A, B, and C” or “at least one of the following: A, B, and C” means “only A, or only B, or only C, or any combination of A, B, and C.”

Additionally, for the purposes of explanation and non-limitation, specific details, such as functional entities, techniques, protocols, standards, and the like, are set forth to provide an understanding of the described technology. In other examples, detailed descriptions of well-known methods, technologies, systems, architectures, and the like are omitted so as not to obscure the description with unnecessary details.

Persons skilled in the art will immediately recognize that any network functions or algorithms described in the present disclosure may be implemented by hardware, software, or a combination of software and hardware. Described functions may correspond to modules which may be software, hardware, firmware, or any combination thereof. The software implementation may comprise computer executable instructions stored on computer computer-readable medium, such as memory or other types of storage devices. For example, one or more microprocessors or general-purpose computers with communication processing capability may be programmed with corresponding executable instructions and carry out the described network functions or algorithms. The microprocessors or general-purpose computers may be formed of Applications Specific Integrated Circuitry (ASIC), programmable logic arrays, and/or using one or more Digital Signal Processors (DSPs). Although some of the example implementations described in this specification are oriented to software installed and executing on computer hardware, nevertheless, alternative example implementations implemented as firmware or as hardware or a combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, a 5G New Radio (NR) Radio Access Network (RAN) or a 6G NR RAN) typically includes at least one Base Station (BS), at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a 5G Core (5GC), or the Internet), through a RAN established by one or more BSs.

It should be noted that, in the present disclosure, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GRPS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), 6G, and/or LTE-A Pro. However, the scope of the present disclosure should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a NG-eNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides services to serve one or more UEs within its radio coverage (e.g., each cell schedules the downlink and optionally uplink resources to at least one UE within its radio coverage for downlink and optionally uplink packet transmissions). The BS can communicate with one or more UEs in the radio communication system through a plurality of cells. A cell may allocate Sidelink (SL) resources for supporting Proximity Service (ProSe) or Vehicle to Everything (V2X) service. Each cell may have overlapped coverage areas with other cells.

In addition, the terms “system” and “network” herein may be used interchangeably. The term “and/or” herein is only an association relationship for describing associated objects and represents that three relationships may exist. For example, A and/or B may indicate that: A exists alone, A and B exist at the same time, or B exists alone. In addition, the character “/” herein generally represents that the former and latter associated objects are in an “or” relationship.

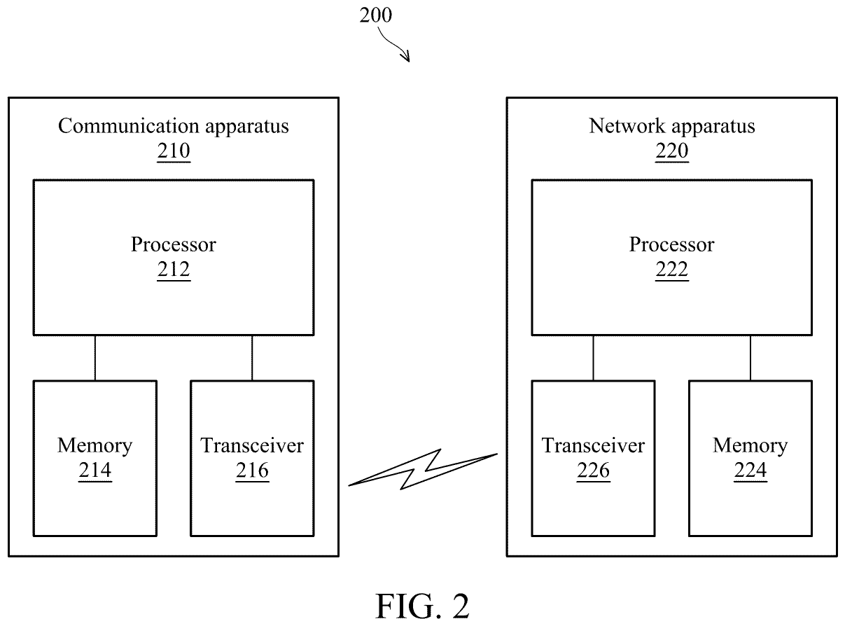

FIG. 2 illustrates an example communication system 200 having at least an example communication apparatus 210 and an example network apparatus 220 in accordance with an implementation of the present disclosure. Each of the communication apparatus 210 and network apparatus 220 may perform various functions to implement schemes, techniques, processes, and methods described herein pertaining to detecting abnormal packet transmission latency in mobile communications, including scenarios/schemes described above, as well as process 300 described below.

Communication apparatus 210 may be a part of an electronic apparatus, which may be a UE such as a portable or mobile apparatus, a wearable apparatus, a wireless communication apparatus, or a computing apparatus. For instance, communication apparatus 210 may be implemented in a smartphone, a smartwatch, a personal digital assistant, a digital camera, or a computing equipment such as a tablet computer, a laptop computer, or a notebook computer. Communication apparatus 210 may also be a part of a machine-type apparatus, which may be an IoT, NB-IoT, or IIoT apparatus, such as an immobile or a stationary apparatus, a home apparatus, a wire communication apparatus, or a computing apparatus. For instance, communication apparatus 210 may be implemented in a smart thermostat, a smart fridge, a smart door lock, a wireless speaker, or a home control center. Alternatively, communication apparatus 210 may be implemented in the form of one or more integrated-circuit (IC) chips, such as, for example, and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2, such as a processor 212, for example. Communication apparatus 210 may further include one or more other components not pertinent to the proposed scheme of the present disclosure (e.g., internal power supply, display device and/or user interface device), and, thus, such components of communication apparatus 210 are neither shown in FIG. 2 nor described below in the interest of simplicity and brevity.

Network apparatus 220 may be a part of a network apparatus, which may be a network node such as a satellite, a base station, a small cell, a router, or a gateway. For instance, network apparatus 220 may be implemented in an eNB in an LTE network, in a gNB in a 5G/NR, IoT, NB-IoT, or IIoT network, or in a satellite or base station in a 6G network. Network apparatus 220 may include at least some of those components shown in FIG. 2, such as a processor 222, for example. Processor 222 may further include protocol stacks and a set of control functional modules and circuits. Network apparatus 220 may further include one or more other components not pertinent to the proposed scheme of the present disclosure (e.g., internal power supply, display device, and/or user interface device), and, thus, such components of network apparatus 220 are neither shown in FIG. 2 nor described below in the interest of simplicity and brevity.

In one aspect, each of the processor 212 and processor 222 may be implemented in the form of one or more single-core processors, one or more multi-core processors, or one or more CISC processors. That is, even though a singular term “a processor” is used herein to refer to processor 212 and processor 222, each of the processor 212 and processor 222 may include multiple processors in some implementations and a single processor in other implementations in accordance with the present disclosure. In another aspect, each of the processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 212 and processor 222 is a special-purpose machine specifically designed, arranged, and configured to perform specific tasks in a device (e.g., as represented by communication apparatus 210) and a network (e.g., as represented by network apparatus 220) in accordance with various implementations of the present disclosure.

In some implementations, communication apparatus 210 may also include a memory 214 coupled to processor 212 and capable of being accessed by processor 212 and storing data therein. In some implementations, communication apparatus 210 may further include a transceiver 216 coupled to processor 212 and capable of wirelessly transmitting and receiving data.

In some implementations, network apparatus 220 may further include a memory 224 coupled to processor 222 and capable of being accessed by processor 222 and storing data therein, and a transceiver 226 coupled to processor 222 and capable of wirelessly transmitting and receiving data. Accordingly, communication apparatus 210 and network apparatus 720 may wirelessly communicate with each other via transceiver 216 and transceiver 226, respectively.

For illustrative purposes and without limitation, descriptions of capabilities of the communication apparatus 210 and network apparatus 220 are provided below with process 300. In which, communication apparatus 210 is implemented in or as a communication apparatus or a UE, and network apparatus 220 is implemented in or as a network node of a communication network (e.g., a base station).

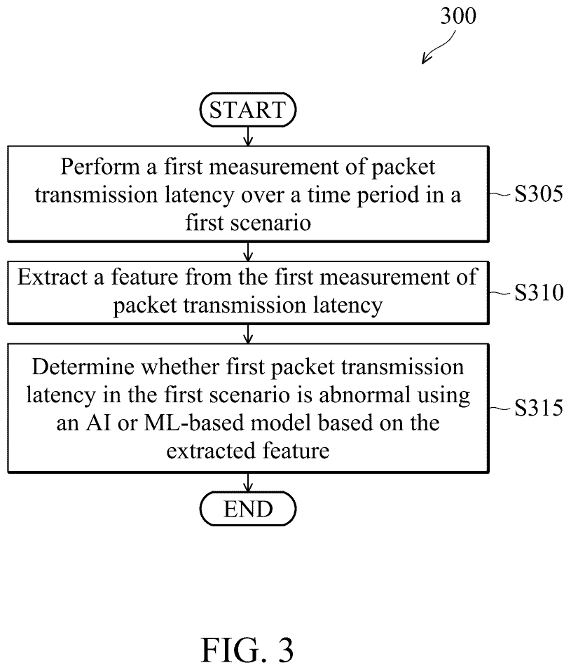

FIG. 3 illustrates an example process 300 in accordance with an implementation of the present disclosure. Process 300 may be an example implementation of the above scenarios/schemes, whether partially or completely, with respect to detecting abnormal packet transmission latency. Process 300 may represent an aspect of the implementation of features of communication apparatus 210. Process 300 may include one or more operations, actions, or functions as illustrated by one or more of blocks S305, S310, and S315. Although illustrated as discrete blocks, various blocks of process 300 may be divided into additional blocks, combined into fewer blocks, or eliminated, depending on the desired implementation.

Moreover, the blocks of process 300 may be executed in the order shown in FIG. 3 or, alternatively, in a different order. Process 300 may be implemented by communication apparatus 210 or any suitable UE or machine-type devices. Solely for illustrative purposes and without limitation, process 300 is described below in the context of communication apparatus 210 as a UE or a wireless device. It should be noted that before process 300 begins, it is assumed that the AI or ML-based model has been trained. Process 300 may begin at block S305.

At block S305, process 300 may involve processor 212 of communication apparatus 210 performing a first measurement of packet transmission latency over a time period in a first scenario. In one embodiment, the time period is one second. Process 300 may proceed from block S305 to block S310.

At block S310, process 300 may involve processor 212 extracting a feature from the first measurement of packet transmission latency.

At block S315, process 300 may involve processor 212 determining whether first packet transmission latency in the first scenario is abnormal using an AI or ML-based model based on the extracted feature.

In some implementations, the first feature includes a maximum packet transmission latency over the time period. In other words, this feature represents the highest packet transmission latency observed within the time period. It is determined by identifying the maximum latency value among all packets transmitted during that time period.

In some implementations, the first feature includes a severity of packet transmission latency over the time period. This feature quantifies the overall severity of packet transmission latency experienced within the time period. The severity of packet transmission latency may be defined using various statistical or weighted metrics, such as average latency in the time period or binned latency weights.

In one embodiment, the binned latency weights approach is selected to represent the severity of packet transmission latency. Specifically, all latency values observed in the first measurement of packet transmission latency during the time period are segmented or classified into a predetermined number of bins, wherein each bin corresponds to a latency range (e.g., 0-150 ms, 150-250 ms, 250-500 ms, 500-1000 ms, greater than 1000 ms, etc.) and the latency range corresponding to each bin may be different. Each bin is associated with a respective weight that reflects the relative severity of packet transmission latency within that latency range. For the given time period, the proportion (or percentage) of packets falling into each bin is determined, and the severity of packet transmission latency for that time period is calculated as a weighted sum according to their respective proportions and weights. This representation allows the AI or ML-based model to capture not only the magnitude but also the distribution characteristics of packet transmission latency over time.

In some implementations, process 300 may involve processor 212 performing a second measurement of packet transmission latency over the time period in a second scenario when the first scenario is changed to the second scenario. Process 300 may further involve processor 212 updating the AI or ML-based model to obtain an updated AI or ML-based model by using normal data in a latency range from the second measurement of packet transmission latency in the second scenario. Process 300 may further involve processor 212 determining whether second current packet transmission latency in the second scenario is abnormal using the updated AI or ML-based model.

In some implementations, process 300 may involve processor 212 establishing a threshold based on a second feature extracted from the normal data in the latency range. Process 300 may further involve processor 212 determining that the second current packet transmission latency in the second scenario is abnormal when an output corresponding to the second current packet transmission latency from the updated AI or ML-based model exceeds the threshold.

In yet another implementation, process 300 may involve processor 212 determining that the first scenario is changed when one of the following occurs: a location of the wireless device changes, an application currently used by the wireless device changes, and a serving cell of the wireless device changes.

In some implementations, the AI or ML-based model comprises statistical methods, examples of which include Z-score analysis and Interquartile Range (IQR) analysis.

In some implementations, the AI or ML-based model comprises machine learning algorithms, examples of which include Isolation Forest, One-Class SVM, and Local Outlier Factor (LOF).

In some implementations, the AI or ML-based model is a deep neural network, examples of which include Convolutional Neural Networks (CNNs), autoencoders, and Recurrent Neural Networks (RNNs).

The following details how the AI or ML-based model is trained. It should be noted that the severity of packet transmission latency is used as a feature to illustrate in the following embodiment, and those skilled in the art can make appropriate replacements or adjustments according to this embodiment.

In this embodiment, the severity of packet transmission latency within a time period (e.g., one-second interval) is evaluated using a binned latency weights approach. In this approach, the packet transmission latency observed during the time period are categorized or segmented into a predetermined number of bins, and a weighted sum is calculated based on the proportion of packets that fall within each bin.

For example, the packet transmission latency may be divided into five bins as shown in TABLE 1.

TABLE 1

| Bin | Latency Range (ms) |
|---|---|
| 1 | 0-150 |
| 2 | 150-250 |
| 3 | 250-500 |
| 4 | 500-1000 |
| 5 | Greater than 1000 |

For each bin, the proportion of packets whose packet transmission latency fall within the respective range is determined. This results in a set of proportions (P₁, P₂, . . . , Pₙ), one for each bin. Each bin is associated with a predefined weight (W₁, W₂, . . . , Wₙ) that reflects the relative severity of the corresponding latency range. The weights may be determined based on empirical data or configured according to the impact of latency on network performance. The severity of packet transmission latency for the given time period is calculated by multiplying the proportion of packets in each bin by the corresponding weight and summing these weighted values. The severity score may be expressed as:

$$Severity = {\sum }_{i = 1}^{n} ( {P}_{i} \times {W}_{i} )$$

wherein n denotes the number of latency bins, Pᵢ is the proportion of packets in bin i, and Wᵢ is the weight assigned to bin i. The calculated severity score provides a quantitative measure of latency severity for the time period. When the severity score exceeds a predetermined threshold, the AI or ML-based model may determine that the current packet transmission latency in the current scenario is abnormal or a high packet transmission latency condition has occurred.

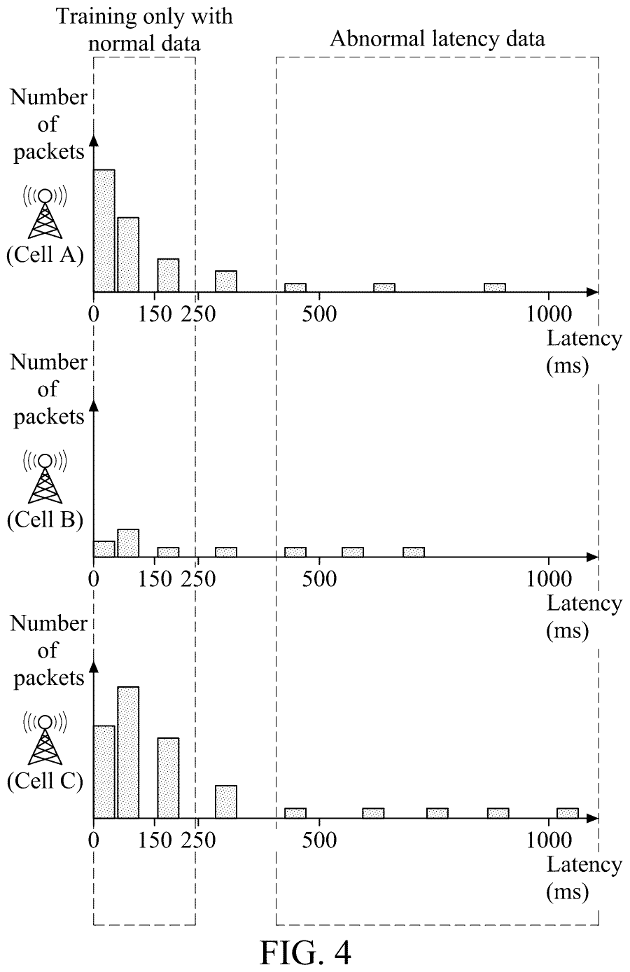

In one embodiment, the AI or ML-based model used for detecting high packet transmission latency or detecting abnormal packet transmission latency is implemented as an autoencoder. The autoencoder is trained using normal packet transmission latency data collected from one or more cells. As shown in FIG. 4, the training data include packet latency distributions from multiple cells (e.g., Cell A, Cell B, and Cell C). Each histogram represents the number of packets corresponding to different latency ranges. During training, only normal latency samples (i.e., latency values below a predefined range, such as 250 ms) are used, while abnormal latency data are excluded.

During training, the normal input feature vectors (e.g., severity scores, etc.) are fed into the AI or ML-based model (e.g. an autoencoder model), which attempts to reconstruct the input at its output. The loss function is defined as the mean squared error (MSE) between the input and the reconstructed output. Through iterative optimization, the autoencoder learns to accurately reconstruct normal latency patterns while yielding larger reconstruction errors for anomalous latency patterns that deviate from the training distribution.

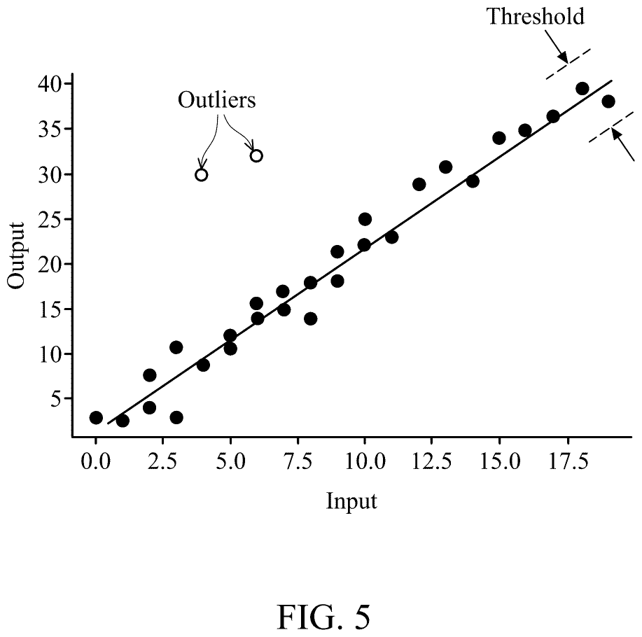

After training is completed, the AI or ML-based model is validated using a separate validation dataset containing normal samples. The threshold for anomaly detection is determined based on the maximum validation loss observed during the training and validation phases. As illustrated in FIG. 5, when the reconstruction loss for an input sample exceeds this threshold, the AI or ML-based model determines that the current packet transmission latency in the current scenario is abnormal or that a high packet transmission latency condition has occurred. The points exceeding this threshold can be regarded as outliers or abnormal latency events.

This threshold-based detection mechanism enables the AI or ML-based model to dynamically identify latency anomalies without requiring explicit rule-based thresholds for each environment or application. Instead, the AI or ML-based model learns the statistical characteristics of normal latency behavior and automatically detects abnormal deviations, such as high packet transmission latency spikes or irregular latency distributions. This approach improves adaptability across different network conditions and ensures accurate detection of high/abnormal packet transmission latency events.

It should be noted that the description related to FIG. 4 and FIG. 5 focuses on the initial training process of the AI or ML-based model for detecting abnormal packet transmission latency. When the scenario changes, such as changes in the user's location, environment, network conditions, or application type, the trained AI or ML-based model may no longer accurately represent the new latency characteristics. In such cases, the AI or ML-based model may be retrained or updated to adapt to the new scenario. The retraining process may be derived from, and follows, the same procedures described in FIG. 4 and FIG. 5, including feature extraction, data preparation using normal latency samples, model training with reconstruction-based loss, and threshold determination based on validation loss.

As described above, the method and apparatus for detecting abnormal packet transmission latency proposed in the present disclosure uses AI or ML-based feature analysis and adaptive thresholding. The threshold used for detecting high/abnormal packet transmission latency may be adaptively adjusted according to different scenarios. Moreover, when the network environment or usage scenario changes, the AI or ML-based model may be retrained following the same procedures, ensuring that the detection accuracy is maintained under new scenarios to improve overall user experience and network performance.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for detecting abnormal packet transmission latency, wherein the method is implemented by a wireless device, and comprises:
performing a first measurement of packet transmission latency over a time period in a first scenario;
extracting a first feature from the first measurement of packet transmission latency; and
determining whether first current packet transmission latency in the first scenario is abnormal using an artificial intelligence (AI) or machine-learning (ML)-based model based on the first feature.

2. The method for detecting abnormal packet transmission latency as claimed in claim 1, wherein the first feature includes a maximum packet transmission latency over the time period.

3. The method for detecting abnormal packet transmission latency as claimed in claim 1, wherein the first feature includes a severity of packet transmission latency over the time period.

4. The method for detecting abnormal packet transmission latency as claimed in claim 3, wherein the severity of packet transmission latency over the time period is evaluated based on average latency in the time period.

5. The method for detecting abnormal packet transmission latency as claimed in claim 3, wherein the severity of packet transmission latency over the time period is evaluated by:
segmenting latency values in the first measurement of packet transmission latency into a predetermined number of bins, wherein each bin is associated with a respective weight; and
calculating the severity of packet transmission latency based on a proportion of packets in each bin and the respective weight corresponding to each bin.

6. The method for detecting abnormal packet transmission latency as claimed in claim 1, further comprising:
performing a second measurement of packet transmission latency over the time period in a second scenario when the first scenario is changed to the second scenario;
updating the AI or ML-based model to obtain an updated AI or ML-based model by using normal data in a latency range from the second measurement of packet transmission latency in the second scenario; and
determining whether second current packet transmission latency in the second scenario is abnormal using the updated AI or ML-based model.

7. The method for detecting abnormal packet transmission latency as claimed in claim 6, further comprising:
establishing a threshold based on a second feature extracted from the normal data in the latency range; and
determining that the second current packet transmission latency in the second scenario is abnormal when an output corresponding to the second current packet transmission latency from the updated AI or ML-based model exceeds the threshold.

8. The method for detecting abnormal packet transmission latency as claimed in claim 1, wherein the AI or ML-based model comprises statistical methods, including at least one of Z-score analysis and Interquartile Range (IQR) analysis.

9. The method for detecting abnormal packet transmission latency as claimed in claim 1, wherein the AI or ML-based model comprises machine learning algorithms, including at least one of Isolation Forest, One-Class SVM, and Local Outlier Factor (LOF).

10. The method for detecting abnormal packet transmission latency as claimed in claim 1, wherein the AI or ML-based model is a deep neural network including at least one of Convolutional Neural Networks (CNNs), autoencoders, and Recurrent Neural Networks (RNNs).

11. An apparatus for detecting abnormal packet transmission latency, comprising:
a memory; and
at least one processor coupled to the memory, wherein the at least one processor performs operations comprising:
performing a first measurement of packet transmission latency over a time period in a first scenario;
extracting a first feature from the first measurement of packet transmission latency; and
determining whether first current packet transmission latency in the first scenario is abnormal using an artificial intelligence (AI) or machine-learning (ML)-based model based on the first feature.

12. The apparatus for detecting abnormal packet transmission latency as claimed in claim 11, wherein the first feature includes a maximum packet transmission latency over the time period.

13. The apparatus for detecting abnormal packet transmission latency as claimed in claim 11, wherein the first feature includes a severity of packet transmission latency over the time period.

14. The apparatus for detecting abnormal packet transmission latency as claimed in claim 3, wherein the severity of packet transmission latency over the time period is evaluated based on average latency in the time period.

15. The apparatus for detecting abnormal packet transmission latency as claimed in claim 13, wherein the severity of packet transmission latency over the time period is evaluated by:
segmenting latency values in the first measurement of packet transmission latency into a predetermined number of bins, wherein each bin is associated with a respective weight; and
calculating the severity of packet transmission latency based on a proportion of packets in each bin and the respective weight corresponding to each bin.

16. The apparatus for detecting abnormal packet transmission latency as claimed in claim 11, wherein the processor further performs operations comprising:
performing a second measurement of packet transmission latency over the time period in a second scenario when the first scenario is changed to the second scenario;
updating the AI or ML-based model to obtain an updated AI or ML-based model by using normal data in a latency range from the second measurement of packet transmission latency in the second scenario; and
determining whether second current packet transmission latency in the second scenario is abnormal using the updated AI or ML-based model.

17. The apparatus for detecting abnormal packet transmission latency as claimed in claim 16, wherein the processor further performs operations comprising:
establishing a threshold based on a second feature extracted from the normal data in the latency range; and
determining that the second current packet transmission latency in the second scenario is abnormal when an output corresponding to the second current packet transmission latency from the updated AI or ML-based model exceeds the threshold.

18. The apparatus for detecting abnormal packet transmission latency as claimed in claim 11, wherein the AI or ML-based model comprises statistical methods, including at least one of Z-score analysis and Interquartile Range (IQR) analysis.

19. The apparatus for detecting abnormal packet transmission latency as claimed in claim 11, wherein the AI or ML-based model comprises machine learning algorithms, including at least one of Isolation Forest, One-Class SVM, and Local Outlier Factor (LOF).

20. The apparatus for detecting abnormal packet transmission latency as claimed in claim 11, wherein the AI or ML-based model is a deep neural network including at least one of Convolutional Neural Networks (CNNs), autoencoders, and Recurrent Neural Networks (RNNs).
